(19) United States
(12) Patent Application Publication
(10) Pub. No.: US 2008/0169277 A1
(43) Pub. Date: Jul. 17, 2008

(54) LIGHTED WELDING TORCH

(75) Inventors: Richard Mark Achtner, Appleton, WI (US); Bruce Patrick Albrecht, Grayslake, IL (US); LeRoy H. Lauer, Hortonville, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 11/940,200

(22) Filed: Nov. 14, 2007

Related U.S. Application Data
(60) Provisional application No. 60/880,865, filed on Jan. 16, 2007.

(51) Int. Cl. B23K 9/32

(52) U.S. Cl. 219/136

(57) ABSTRACT

Provided is system for aiding a welding operator in positioning a welding device. The system includes a welding device and a light source coupled to the welding device, wherein the light source is configured to generate a focused beam of light that is configured to illuminate a weld location. The configuration of the light source's illumination may provide for aligning and positioning of the welding device relative to a work piece or other surface.

### CROSS REFERENCE TO RELATED APPLICATIONS

This application claims priority to U.S. Provisional Patent Application No. 60/880,865, entitled “Lighted Welding Torch”, filed on Jan. 16, 2007, which is herein incorporated by reference.

### BACKGROUND

The invention relates generally to the field of welding systems, and particularly to welding systems that require alignment of a torch and/or electrode to a desired weld location.

A number of forms of welding are known and are generally used in the art. These include metal inert gas (MIG) welding, tungsten inert gas (TIG) welding, and stick welding systems. In MIG systems, electrical current is applied to a wire electrode and an arc is established between a grounded work piece and the electrode. The wire electrode is advanced through a welding torch and is generally consumed as the work piece is melted due to heat released by a sustained arc, while a shielding gas surrounds the progressing weld. A variant of MIG welding is flux core arc welding (FCAW), in which a flux is integrated into welding wire and no shielding gas is required. Stick welding involves establishing an arc between a stick electrode which is often surrounded by a flux material. The stick electrode is generally consumed and its metal is fused with melted metal of the work piece as the welding operation continues under the heat of an established arc. In TIG welding, on the contrary, a non-consumable tungsten electrode is used to establish an arc with a work piece, causing the work piece material to melt and fuse to form a weld, often with the addition of consumable material which is melted and added to weld under the heat of the arc. These welding techniques may be used on different types of material or for different applications, but multiple techniques are often used by a welding operator depending upon the particular needs of an application.

One difficulty in welding applications is positioning and aligning the electrode with respect to a desired weld location. This concern is prevalent in TIG welding systems (also known as gas tungsten arc welding, or, GTAW), because the electrode is suspended above the work piece. In a TIG welding system, prior to and during the welding process, the weld area is protected from atmospheric contamination by a shielding gas (typically an inert gas) expelled from the tip of the welding torch to encapsulate the electrode, the weld location and the tip of a filler material. As briefly mentioned above, a non-consumable tungsten electrode is contained in a torch to provide a path for current flow to a work piece. When the energized electrode is positioned close to the grounded work piece, an electric arc is formed. The arc provides an intense heat that melts the work piece and surrounding metals to create a weld. In general, the arc is struck when the distance between the tip of the electrode and the work piece is approximately 1.5-3 mm (0.06-0.12 in), depending upon the electrical control regime and its parameters. Once the arc is struck, the welder moves the torch in small circles to create a weld pool, the size of which depends on the size of the electrode and the current level provide by the power source. While maintaining a constant distance between the electrode and the work piece, the torch may be titled at a slight angle to allow for a filler material to be manually added to the front end of the weld pool as is needed to fill any gaps or voids in the weld. This technique may be continued over a distance until the desired weld is complete.

While MIG or FCAW (Metal Inert Gas or Flux Core Arc Welding) maybe less sensitive to positioning the electrode than TIG welding, the distance from the torch and the length of the arc are still of concern. For example, when welding with a consumable electrode (e.g., MIG or FCAW) the arc and the filler material are both supplied via the consumable electrode which is positioned above the work piece. The distance between the electrode and work piece may affect the weld penetration as well as how the filler material is deposited. Thus, the distance between the electrode and the work piece is crucial to making a quality weld.

Properly aligning the electrode may include the positioning the electrode relative to the desired weld location on the work piece, as well as maintaining a proper distance between the tip of the electrode and the work piece. If the electrode is not aligned properly, the weld may be formed in the wrong location, the weld may have an inconsistent cross section, or the arc may be extinguished during the welding process. At present, the alignment of the electrode to the work piece is generally accomplished by an operator holding a torch or gun with an electrode, estimating the resulting arc location (i.e., weld location) on the work piece and estimating the proper distance from the tip of the electrode to the work piece, or simply touching the work piece to initiate the arc. During welding, proper distancing of the electrode from the work piece typically relies upon the skill and experience of the operator. This method of alignment is not precise and may lead to a weld in the wrong location, or a weld of low quality due to the electrode arcing at an improper distance from the work piece.

Moreover, most welding applications provide little or insufficient light to allow the welder to see any of the work piece or components once the arc is struck. That is, while work lamps may be used to illuminate a work area, once the welding operator lowers his welding shield, or transitions an autodarkening shield to a dark shade, the operator will have little or no visual feedback of the location of the electrode tip or its distance from the work piece other than the light provided by the arc.

Accordingly, there is a need for an improved welding system that provides for proper alignment of a torch and/or an electrode prior to and during the welding process. There is also a need for a technique for lighting welding locations, particularly to provide an indication of the position and orientation of a welding electrode and/or general lighting in the workplace.

### BRIEF DESCRIPTION

The invention provides a welding arrangement designed to respond to such needs. In accordance with one aspect of the present invention, a welding system includes a welding device, and a guide light coupled to the welding device. The guide light is configured to illuminate a location at or near a weld location. In a particular embodiment, the device is the welding torch/gun itself, and the guide light is supported on the torch/gun or the torch/gun handle.

In accordance with another aspect of the present invention, a TIG welding torch or MIG welding gun system is provided that includes a TIG welding torch or MIG welding gun and a guide light coupled to the TIG welding torch or MIG welding gun. The guide light is configured to illuminate a location at or near a weld location.

In accordance with yet another aspect of the present technique, a welding lighting system includes a guide light and an enclosure configured to encompass the guide light and configured to couple the guide light to a welding device.

In all of these configurations, the guide light or lighting system may actually include more than one light source. Thus, a single laser or LED, for example, may serve to illuminate a weld area, while more than one laser or LED may provide particular functionality, such as focusing, general illumination, distance indication, and so forth.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of an exemplary TIG welding system in accordance with aspects of the present invention;

FIG. 2 is an illustration of an exemplary embodiment of the torch of the welding system of FIG. 1 in accordance with aspects of the present invention;

FIG. 3 is an illustration of an alternate exemplary embodiment of the torch of the welding system of FIG. 1 in accordance with aspects of the present invention;

FIGS. 4A is an illustration of an exemplary embodiment of the underside of the light assembly and torch of FIGS. 2 and 3 including a single light source configuration in accordance with aspects of the present invention;

FIGS. 4B is an illustration of an exemplary embodiment of the underside of the light assembly and torch of FIGS. 2 and 3 including a two-light source configuration in accordance with aspects of the present invention;

FIGS. 4C is illustration of an exemplary embodiment of the underside of the light assembly and torch of FIGS. 2 and 3 including a three-light source configuration in accordance with aspects of the present invention;

FIGS. 4D is an illustration of an exemplary embodiment of the underside of the light assembly and torch of FIGS. 2 and 3 including a four-light source configuration in accordance with aspects of the present invention;

FIGS. 4E is an illustration of an exemplary embodiment of the underside of the light assembly and torch of FIGS. 2 and 3 including a four-light source and single sensor configuration in accordance with aspects of the present invention;

FIG. 5 is an illustration of an alternate exemplary embodiment of the light assembly and torch of FIG. 4B configured to triangulate a position in accordance with aspects of the present invention;

FIG. 6 is an illustration of an alternate exemplary embodiment of the light assembly and torch of FIG. 4A configured to provide a cone of light in accordance with aspects of the present invention;

FIG. 7 is a diagrammatical illustration of an exemplary embodiment of a remote trigger mechanism of the system of FIG. 1 in accordance with aspects of the present invention;

FIG. 8 is a diagrammatical illustration of an exemplary embodiment of a manual trigger mechanism of the system of FIG. 1 in accordance with aspects of the present invention;

FIG. 9 is a diagrammatical illustration of an exemplary embodiment of a sensor trigger mechanism of the system in FIG. 1 in accordance with aspects of the present invention;

FIG. 10 is an illustration of an exemplary embodiment of the power wire leads relative to the torch of FIG. 2 in accordance with aspects of the present invention; and

FIG. 11 is an illustration of an alternate embodiment of the torch of FIG. 2 in accordance with aspects of the present invention;

### DETAILED DESCRIPTION

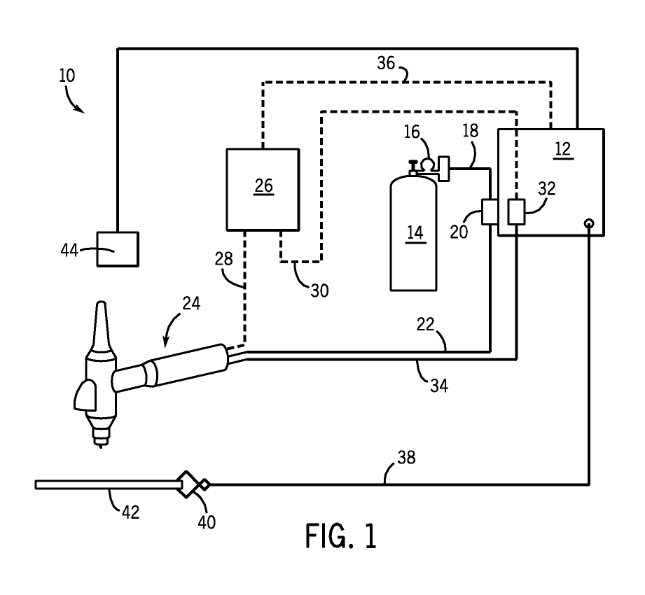

Referring now to FIG. 1, a welding system 10 in accordance with one embodiment of the present technique is illustrated. The welding system 10 may generally include multiple welding components and devices. As depicted, a TIG welding system 10 may include a power source 12, a shielding gas source 14, a cooling system 26 and a torch 24.

In the illustrated embodiment, the power source 12 provides power to the welding torch 24 via a supply conduit 22. The power source 12 may supply a DC current or AC current to the torch 24 depending on the desired application. For example, an AC current may be suited for welding aluminum or magnesium, and a DC current may be suited for welding stainless steels, nickel or titanium. In addition to matching the current to the material selection, the output of the power source 12 may be varied to obtain desired weld characteristics. For example, a low AC frequency (e.g., 60 Hz) current may generate a wide arc with shallow penetration of a work piece 42, while a high AC frequency (e.g., 200 Hz) current may generate a focused arc with deeper penetration of the work piece.

In addition to the frequency of the current, the power source 12 may vary the amperage of the current output to the torch 24. The setting for the amperage output by the power source 12 may be adjusted by a setting a knob or button on the power source 12, or may be set by a remote control 44. For example, a welding system 10 may include a foot pedal remote control 44 that allows the operator to make current adjustments during welding by either holding down the foot pedal or feathering the foot pedal remote control 44 to vary the amperage. As will be appreciated, the remote control 44 may also include a finger tip control, audible command, or other form of input to signal the power source 12 to output a corresponding current.

In addition to providing power to the torch 24, in a TIG welding system 10 the torch 24 may be supplied with a shielding gas from a supply 14. In general, the shielding gas may be supplied to the torch 24 and expelled from the torch at the location of the weld. The shielding gas may be expelled immediately prior to striking the welding arc, during welding, and continue until shortly after the welding arc is extinguished. The shielding gas may be used to protect the welding area from atmospheric gases such as nitrogen and oxygen, which can cause fusion defects, porosity, and weld metal embrittlement. The shielding gas may also transfer heat from the welding electrode, discussed below to the metal, and helps to start and maintain a stable arc.

As depicted in FIG. 1, the shielding gas may be provided in a container and delivered to the torch 24 via a regulator 16, a conduit 18, a gas valve 20, and a supply conduit 22. The regulator 16 may allow an operator to limit the pressure of the gas delivered to the gas valve 20 to obtain a desired flow rate. Further, the gas valve 20 may provide for stopping and starting the flow of the shielding gas 14 to the torch 24 in coordination with other welding operations.

The TIG welding systems 10 may be provided with a cooling system 26 to reduce heat build-up. The cooling system may take various forms including gas cooled and liquid cooled systems. The cooling system 26 may provide for circulation of the coolant via conduits 30 and 34. The cooling system may be powered from the power supply 12 via a coolant system power cord 36.

In general, a welding system 10 may provide for current flow by grounding a work piece 42 to the power source 12. For example, as depicted in FIG. 1, the welding and return to the power source via the clamp 40 and the cable 38.

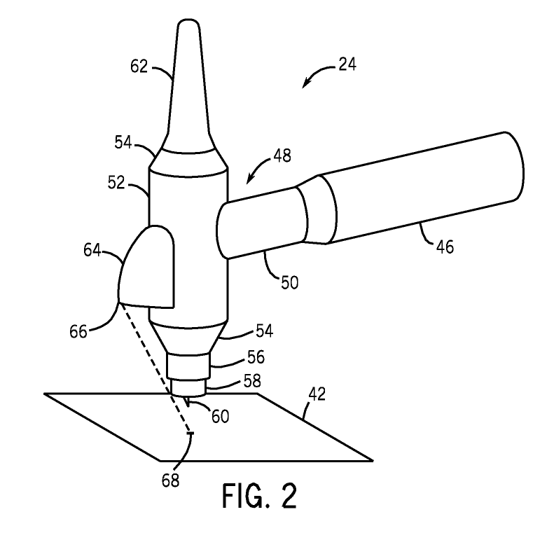

As will be appreciated by those skilled in the art, regardless of the type of welding system used, the operator typically relies upon skill to maintain the proper current and arc to provide a sufficient weld. For example, low heat at the weld caused by a low welding current or high welding speed, can limit the penetration of the weld into the work piece and cause the weld bead to lift away from the weld surface. In contrast, excess heat may allow the weld to grow in size, leading to excessive weld penetration and the potential for splattering of the weld or burning through the work piece. The heat at the weld may be controlled by the distance between the welding torch 24 electrode 60 and the work piece 42 (see FIG. 2). For example, the farther the electrode 60 is from the work piece 42, the larger the voltage the power source 12 must produce and, thus, the more heat that is produced. The additional heat may overheat the torch 24 or excessively heat the weld as described previously.

In addition to the problems associated with heat at the weld location, if the electrode 60 is not well protected by the shielding gas 14, or the operator accidentally allows the electrode 60 to contact the molten metal, the weld pool or the electrode 60 may be come dirty or contaminated. This may cause the weld arc to become unstable, and require the electrode 60 to be reground to remove the impurity. In conventional welding systems, the operator must approximate the distance between the electrode 60 and the work piece 42. Thus, the quality of the weld, and the efficient operation of the welding torch 24 relies on the skill of the operator to maintain a proper distance between the electrode 60 and the work piece 42. Further, prior to starting the weld, the operator may have to estimate the location of the arc due to the distance that may be required between the electrode 60 and the work piece 42. For example, to strike an arc with the aid of a “high frequency” current, the operator may have to initiate the current while suspending the electrode 60 above the work piece 42. Further, in other systems, a “lift-arc start” may require touching the electrode to the work piece 42 and slowly moving the electrode away from the work piece 42 until an arc is struck. If the operator does not estimate the correct position of the arc with either of the above techniques, the weld may be started in an undesired location.

As illustrated in FIG. 2, a TIG welding torch 24 in accordance with an embodiment of the present technique includes a handle 46 that is attached to a torch body 48. The handle 46 will typically have a hollow interior to allow for routing power, shielding gas and coolant to the welding torch 24. The torch body 48 may include a torch neck 50 and a torch head 52. The torch body 48 may provide for a central-rigid support to mount all of the necessary hardware of a TIG welding torch 24. For example, the torch neck 50 provides for securing the handle 46 to other components, and thereby allows an operator to hold and manipulate the welding torch 24 and its components via the handle 46.

Other components of the welding torch 24 coupled to the torch body 48 may include an insulator 54, a nozzle 56, a collet 58, an electrode 60, and a back cap 62. The insulator 54 may be positioned on the interior of the torch body 48 to prevent heat produced by the welding current from passing into the torch body 48 and/or the handle 46. The nozzle 56 may be attached to the insulator 54 or the torch head 52 of the torch body 48. The nozzle 56 may include a hollow tubular shaped piece that encloses the collet 58 and the electrode 60, while providing a path for the shielding gas to pass between an interior surface of the nozzle 56 and the collet 58.

In the embodiment illustrated in FIG. 2, the welding torch 24 includes a light for illuminating the weld location, such as for guiding the operator as to the location of the weld arc. As depicted in FIG. 2, the welding torch 24 includes a light assembly 64 coupled to the torch head 52 and a guide light (discussed in detail below) producing a beam of light 66. In one embodiment, the guide light may include a laser diode that emits a beam of light onto the work piece 42 at an anticipated arc location 68. For example, as depicted by FIG. 2, the guide light beam 66 may be a narrow beam of light that is focused to provide a “dot” of light on the surface of the work piece 42 at the arc location 68. In certain embodiments, the beam of light has a diameter of less than about 10 mm, less than about 5 mm, less than about 4 mm, less than about 3 mm, less than about 2 mm, or even less than about 1 mm. In this configuration, it may be possible for an operator to locate this “dot” prior to initiating the weld (i.e., triggering the current from the power supply) and determine the location of the weld relative to the location of the electrode 60 and the welding torch 24. As will be appreciated by those skilled in the art, the guide light beam 66 may be varied to accommodate numerous applications. For example, the guide light beam 66 may be configured to provide a “dot” offset from the arc location to align the arc with other reference points. Moreover, the guide light beam 66 may provide a narrow dot to more accurately anticipate the arc location, or a wide dot to allow for more approximately locating the arc.

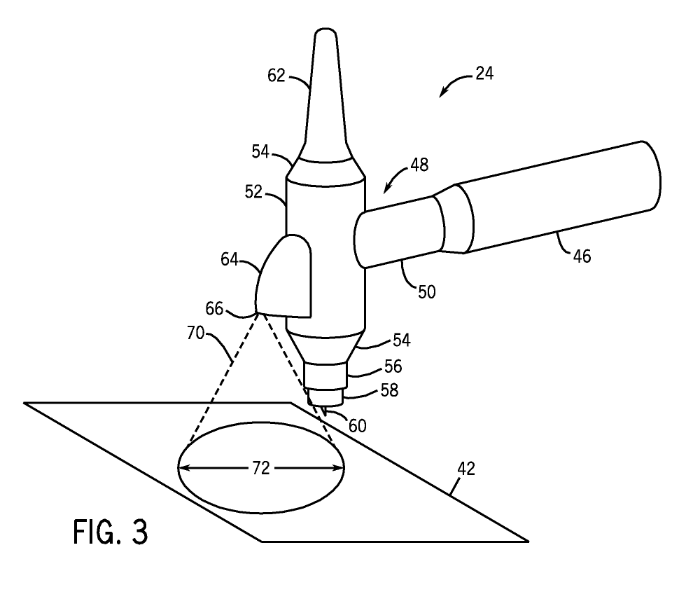

Further, the light assembly 64 may include an area light. For example, as depicted in FIG. 3, the light assembly 64 may produce an unfocused beam 70 that provides for general lighting across a large beam width 72. The beam 70 may provide general lighting for tasks associated with welding, or a light to assist the operator in seeing the work piece 42. For example, the area light may be directed to the weld location such to assist the operator to see the work piece through a welding helmet. As will be appreciated by those skilled in the art, the direction, size, and intensity of the beam 70 as well as the type of light source may be varied to accommodate specific applications.

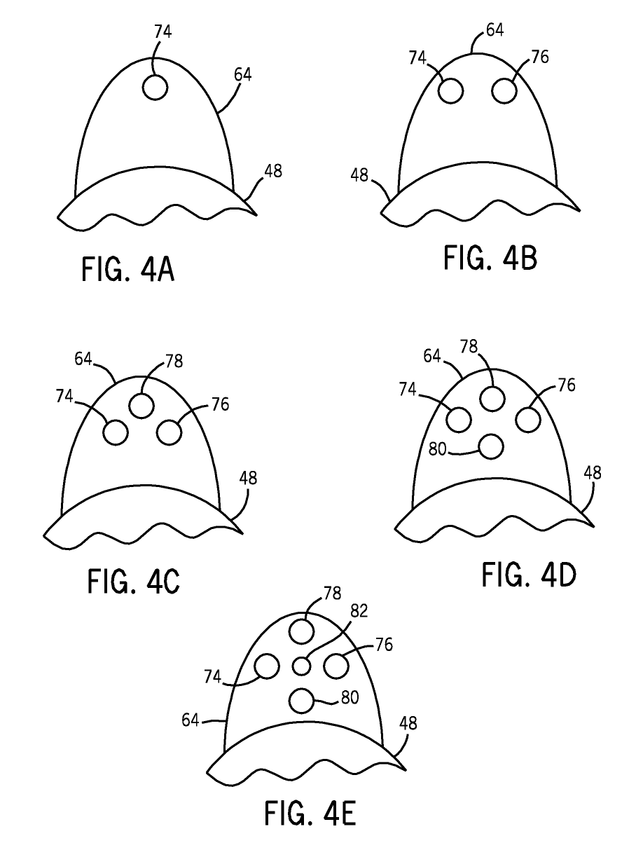

Turning now to FIGS. 4A-4E, the location and combination of light sources and sensors in the light assembly may include numerous configurations. For example, in one embodiment a single light source may be used, as depicted in FIG. 4A. In this arrangement, a light source 74 may be positioned in a light assembly of the assembly, which may include a window or opening to allow light from source 74 to project towards the work piece proximate to the welding torch 24. As will be appreciated by those skilled in the art, the light source 74 may be positioned in any manner that provides sufficient line of sight from the assembly 64 to the location to be illuminated.

In another embodiment, multiple light sources may be provided. For example, as depicted in FIGS. 4B-4E, a first light source 74 may be used in combination with a second light source 76. In certain embodiments, these may be further assembled with a third light source 78 and, where desired a fourth light source 80. As shown in FIG. 4B, in an assembly 64 having two light sources: a first light source 74 and a second light source 76 may include a focused beam of light and an area light. For example, the first light source 74 may project a focused guide light beam (FIG. 2) to visually indicate the arc location on the work piece, and the second light source 76 may project a wide beam of light to illuminate the area proximate to the welding torch. As will be appreciated by those skilled in the art, the location and configuration of each light source in the assembly 64 may be modified to accommodate various applications. For example, the first light source 74 and the second light source 76 may both include area lights.

In the various embodiments described herein, the light sources themselves may be of various types. For example, currently contemplated embodiments would make use of light emitting diodes (LED's) for area lighting, or even certain of the directed lighting. Small lasers may also be used, particularly for more directed or narrowly targeted lighting. These may provide both white light and light in various colors or wavelength bands, as described herein.

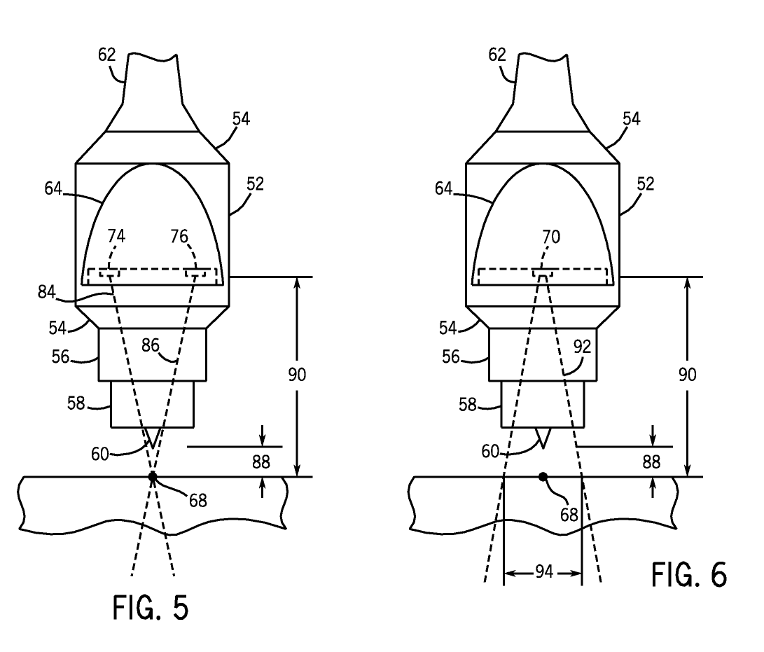

A multi-light embodiment may be configured to provide a visual indication of the arc location 68 as well as the proper arc distance 88, as illustrated generally in FIG. 5. In one embodiment, in FIG. 5, a two light source assembly may be configured to “triangulate” the location of the arc and indicate the proper arc distance 88. For example, a first guide light beam 84 and a second guide light beam 86 may be projected from the first light source 74 and the second light source 76, respectively. Both the first guide light beam 84 and the second guide light beam 86 may be focused beams of light that converge at a desired location, such as the arc location 68 at the proper arc distance 88 (i.e., the distance from the tip of the electrode 60 to the work piece 42). For example, the first light source 74 and second light source 76 may be angled such that their paths cross at a distance 90 and directly under the tip of the electrode 60. This configuration is beneficial to provide a visual indication of the anticipated arc location 68 as well as the position of the electrode 60 relative to the work piece 42. For example, if the torch 24 is held at a distance that exceeds the proper arc distance 88, two separate “dots” (e.g., one dot created by the first guide light beam 84 and a second dot created by the second guide light beam 86) would appear on the work piece 42. Similarly, if the torch 24 is held too close to the work piece 42, again, two separate “dots” would appear on the surface of the work piece 42. Thus, the operator may visually identify that the torch 24 and electrode 60 are at the proper distance when a single dot is created on the work piece 42 by the converging beams of the first guide light beam 84 and the second guide light beam 86.

As will be appreciated by those skilled in the art, two or more light sources may be combined to triangulate a visual indication of the proper arc distance 88 to an arc location 68. For example, as depicted in FIG. 4C, the first light source 74, the second light source 76 and a third light source 78 may each project a beam of light that converge at the arc location 68 and at a proper arc distance 88.

To distinguish the light sources, and provide for various indicators, the color of the light projected may be varied. In one embodiment, a light source may project a color (e.g., red) when the distance between the electrode 60 and the work piece is incorrect, and a light source may project another color (e.g., green) when the distance is within an acceptable range. For example, as depicted in FIG. 4B, the first light source 74 may project in a red color if the distance from the electrode the work piece is outside of a given range. When the distance between the electrode and the work piece is within an acceptable range, the second light source 76 may project a green guide light.

In another embodiment, a third light source may be included to provide additional visual indicators. For example, as depicted in FIG. 4C, a third light source 78 may be provided within the assembly 64 to facilitate an indication of the electrode being too close, too far or at a proper distance from the work piece. For example, if the electrode is too close to the work piece, the first light source 74 may project a blue light at the arc location. However, if the electrode is too far from the work piece, the second light source 76 may project a red light at the arc location. Finally, if the electrode is at a proper distance from the work piece, the third light source 78 may project a green light at the arc location. As will be appreciated by a person of ordinary skill in the art, a variety of light sources and projected lights may be configured in various manners to provide visual indicators to the operator. For example, the number of lights may be increased or provide projections of differing shapes and displays to convey any information useful to the operator and/or the welding process. In addition, those skilled in the art will appreciate that the methods of achieving the desired displays may be varied. For example, a transparent color wheel may be located beneath a single light source to provide the variety of colors in the configurations described above.

The assembly 64 may incorporate other devices for providing feedback to the operator, in addition to the light sources. In on embodiment, the light assembly 64 may include a proximity sensor 82, as depicted in FIG. 4E. In the exemplary embodiment shown, the assembly 64 may include a plurality of light sources 74, 76, 78, and 80 and a proximity sensor 82. The proximity sensor may provide information relating to the relative distance from the proximity sensor 82 to the work piece and, thus, provide information relating to the arc distance. In a presently contemplated embodiment, information provided by the sensor 82 may be combined with previously described embodiments (e.g., multi-colored light sources) to provide feedback to the operator. For example, the proximity sensor 82 may provide a signal representative of the distance from the electrode to the work piece that may be processed to trigger a corresponding first light source 74, second light source 76, third light source 78, or fourth light source 80. In such a configuration, the distance information may be transmitted to the operator via the color, location, or shape of the projected light. As will be appreciated by those skilled in the art, the sensor 82 may take a variety of forms to accommodate various applications. For example sensor 82 may include a photo sensor to detect the presence of ambient light, and thereby adjust the light sources 74, 76, 78 and/or 80 accordingly. In another embodiment, the sensor 82 may include a motion sensing device to indicate movement of the torch and thus provide the means to coordinate the appropriate output of the light sources 74, 76, 78, and/or 80. Such sensors may, of course, be used with fewer light sources than shown in the figure, including a single light source.

To provide visual indication to the operator, the light source may also generate an indicator of a given shape or size on the work piece 42. Such size and shape may allow the operator to determine when the arc location and the arc distance are correct. For example, as depicted in FIG. 6, a guide light cone 92 may be projected from the first light source 74. The guide light cone 92 may project a light in the shape of a circle. Thus, the guide light cone projected may have a given guide cone width 94. An operator may visually recognize the size and shape to identify when the electrode 16 is aligned and at the proper arc distance 88 from the work piece 42. As will be appreciated by those skilled in the art, the size shape and number of guide light comes 92 may be varied to accommodate specific applications.

As will be appreciated by a person of ordinary skill in the art, although all possible combinations of light sources and sensors have not been discussed, any combination of light sources and sensors may be possible to meet the requirements of a given system. For example, a single light source may be combined with multiple sensors, or a colored area light may be combined with multiple laser diodes that triangulate position. The above discussion is not intended to limit the potential embodiments of the disclosed system.

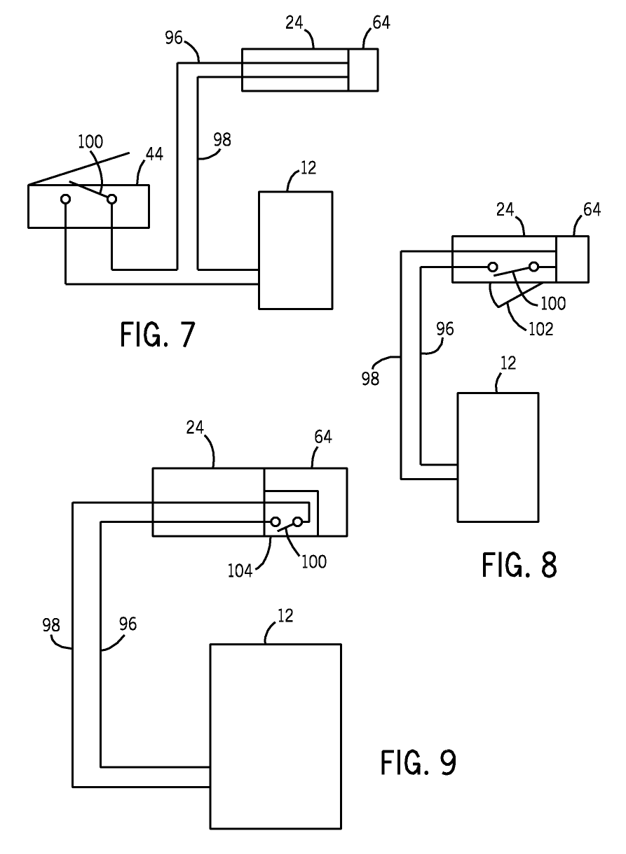

Each of the previously described embodiments may require power to be supplied to the devices contained within the light assembly 64. In one embodiment, the power supplied to light assembly 64 and the light sources 74, 76, 78 and 80, may be remote controlled. For example as depicted in FIG. 7, a foot pedal remote control 44 may be used to control power to the light assembly 64, the light sources 74, 76, 78, and/or 80 and/or a sensor 82. In an embodiment, the foot operated a remote control 44 may include a switch 100 on a first power cable 96 to complete a circuit including a second power cable 98 and the power source 12. In an embodiment, as depicted in FIG. 8, the switch 100 may be activated by a manual trigger 102. For example, the manual trigger 102 may be located on the torch 24 to allow an operator to activate the light sources 74, 76, 78, and 80 and sensor 82 while holding the torch 24. In yet another embodiment, a switch 100 may be activated by a sensor trigger 104. For example, a proximity sensor, motion sensor, or photodetector with in the light assembly 64 may trigger the switch 100. As will be appreciated by a person of ordinary skill in the art, the power supplied may be provided in a variety of configuration to accommodate specific applications.

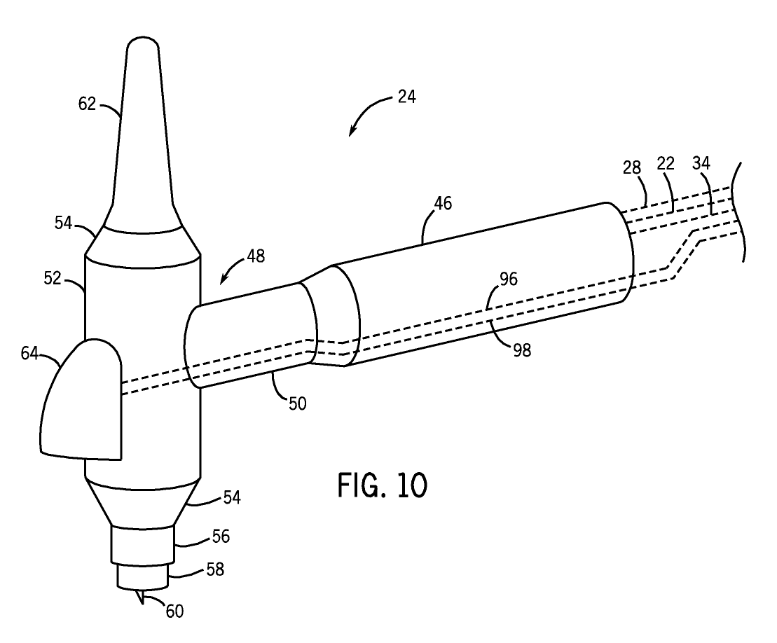

Power supplied to the devices within the assembly 64 may be routed from the power source 12 to the assembly 64 in various manners. In one embodiment, as depicted in FIG. 10, the first power cable 96 and the second power cable 98 may be run through the torch body 48 and the torch handle 46 of the torch 24. This may allow the first power cable 96 and the second power cable 98 to be run in parallel with the coolant-out hose 28, the supply conduit 22 and the torch coolant hose 34 to the power supply 12. As will be appreciated by a person of ordinary skill in the art, the first power cable 96 and the second power cable 98 may be run in any configuration that provides power as required. For example, the first power cable 96 and the second power cable 98 may connect to a battery internal to the assembly 64, or may be run from the assembly 64 to an alternate power source.

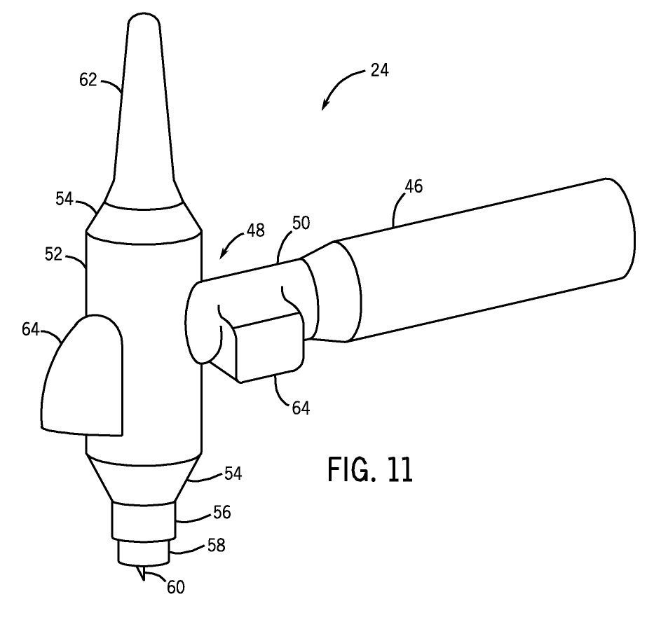

Although previous discussion has included the assembly 64 mounted to the torch head 52, an embodiment may include the assembly 64 mounted to other portions of the torch 24 relative to the electrode 60 and/or weld location. For example, as depicted in FIG. 11, the assembly 64 may be coupled to the torch neck 48. As will be appreciated by those skilled in the art, the assembly 64 may be configured in any manner that provides for the light source and/or sensors to provide appropriate information to the operator. For example, the assembly 64 may be provided as a separate component that is attached external to the torch 24 (e.g., an “add-on” component).

Further, as will be appreciated by those skilled in the art, the present invention may be adapted to other welding techniques. For example, the assembly 64 may be adapted for use on a MIG welding gun, a FCAW welding gun or on torches/guns of similar welding techniques. In one embodiment, the assembly may be coupled to a cutting torch (e.g., a plasma cutter) or similar device to aid the operator in cutting operations. A focused beam of light can illuminate a particular location on a work piece to enable the operator to predict and identify the cutting location. These additional techniques of welding may derive similar benefits from the invention, including alignment of an electrode to a work piece, and general lighting of the work area.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system comprising:
a welding device; and
a light source coupled to the welding device, wherein the light source is configured to generate a focused beam of light that is configured to illuminate a weld location.

2. The welding system of claim 1, wherein the weld location comprises a point where a welding arc is expected to strike a work piece.

3. The welding system of claim 1, comprising a plurality of light sources coupled to the welding device.

4. The welding system of claim 3, wherein each of the plurality of light sources is configured to generate a focused beam of light, and wherein at least two of the plurality of light sources are configured to converge the focused beams of light toward a single point.

5. The welding system of claim 4, wherein the single point is located a distance from an electrode that is within an acceptable range of separation between the electrode and a work piece.

6. The welding system of claim 3, wherein at least one of the plurality of light sources is configured to illuminate an area.

7. The welding system of claim 1, wherein the light source comprises a laser diode.

8. The welding system of claim 1, wherein the light source projects a beam of light of a color that varies based on a distance from an electrode to a work piece.

9. The welding system of claim 1, comprising at least one proximity sensor.

10. The welding system of claim 1, wherein the light source projects a cone shaped beam of light configured to provide a visual indication of a position of the welding device.

11. The welding system of claim 1, wherein the welding device comprises a torch.

12. The welding system of claim 11, wherein the torch comprises a TIG welding torch.

13. The welding torch system of claim 1, wherein the welding device comprises a light assembly having a mount that is configured to couple to a torch.

14. The welding torch system of claim 13, wherein the mount is coupled to a neck or a head of the welding device.

15. A torch system comprising:
a torch; and
a guide light coupled to the torch, wherein the guide light is configured to provide an indication of the location of the torch relative to a work piece.

16. The torch system of claim 15, wherein the guide light is configured to provide a focused beam of light.

17. The torch system of claim 15, wherein the guide light is configured to indicate where an output of the torch is expected to strike the work piece.

18. The torch system of claim 15, wherein the guide light is configured to indicate a distance between the torch and the work piece.

19. The torch system of claim 15, wherein the torch comprises a plasma cutting torch.

20. A torch lighting system, comprising:
a light assembly configured to mount to a torch, the assembly including at least one light source that is configured to generate a focused beam of light proximate a target of the torch.

21. The torch lighting system of claim 20, comprising a plurality of light sources.

22. The torch lighting system of claim 21, wherein the plurality of light sources generate a plurality of focused beams of light that converge at the target.

23. A method, comprising:
generating a beam of light from a light source toward a target to aid with positioning of a torch relative to the target;

24. The method of claim 23, comprising aiding to position the torch at a distance relative to the target based on the beam of light.

25. The method of claim 23, comprising aiming the torch based on where the beam of light strikes the target.
